(19) United States
(12) Patent Application Publication
(10) Pub. No.: US 2014/0378598 A1
(43) Pub. Date: Dec. 25, 2014

(54) Thermoplastic Resin Composition

(71) Applicant: Cheil Industries Inc., Gumi-si (KR)

(72) Inventors: Jung-Eun Park, Uiwang-si (KR); Jin-Uk Ha, Uiwang-si (KR); Chang-Min Hong, Uiwang-si (KR)

(21) Appl. No.: 14/368,598

(22) PCT Filed: Nov. 29, 2012
(86) PCT No.: PCT/KR2012/010204

§ 371 Date: Jun. 25, 2014

(30) Foreign Application Priority Data
Dec. 26, 2011 (KR) 10-2011-0142409

(51) Int. Cl. C08L 69/00

(52) U.S. Cl. CPC C08L 69/00; C08L 2205/03
USPC 524/451

(57) ABSTRACT

Provided is a thermoplastic resin composition that includes 100 parts by weight of a thermoplastic resin including 50 to 90 wt % of a polycarbonate resin; and 10 to 50 wt % of a polyester resin; 1 to 10 parts by weight of a vinyl cyanide compound-aromatic vinyl compound copolymer; and 1 to 10 parts by weight of an inorganic particle; wherein the vinyl cyanide compound in the vinyl cyanide compound-aromatic vinyl compound copolymer is less than or equal to 30 wt %.

### TECHNICAL FIELD

A thermoplastic resin composition is disclosed.

### BACKGROUND ART

Recently, as a material for electro-electronic device part, a vehicle part, and the like, a thermoplastic resin is required to have excellent thermal stability and dimensional stability. In other words, the size of injection molding product is becoming increased by pursuing the cost cutting according to the integrated parts, so the time staying in the injection machine is prolonged, thus the thermal stability of resin is significantly important.

In addition, the shape of injection molding product becomes complicated, and it is deformed after the injection, causing the problem of mismatching the design to be accomplished. Thereby, it is important to suppress the small deformation after the injection, and it is required to suppress the after deformation in the resin itself. The conventional mixture of aromatic polycarbonate and polyethylene terephthalate is mainly used as a part exposed to the impact, due to the high impact resistance.

However, when used for an exterior part of vehicle and the like, the size of the part itself becomes large, causing problems of generating gas due to the low thermal stability upon the injection, and the difficulties for the assembly due to the deformation after the injection are steadily complained.

The aromatic polycarbonate and the polyethylene terephthalate have a weak point of the inferior thermal stability since it may be involved in the transesterification by carboxyl group in the terminal group of polyethylene terephthalate, and the compatibility between two resins is too low to prevent the phase separation during cooling process after the injection, causing the further dimensional deformation after the injection as the secondary result therefrom.

In the case of long and narrow molded product such as a side molding material used in the vehicle exterior product and the like, the problems related to the dimensional stability may be caused depending upon the crystallinity when being mixed with crystalline resin.

### DISCLOSURE

### Technical Problem

One embodiment of the present invention may provide a thermoplastic resin composition with the dimensional stability while maintaining the impact strength.

### Technical Solution

In one embodiment of the present invention, provided is a thermoplastic resin composition including 100 parts by weight of a thermoplastic resin including 50 to 90 wt % of a polycarbonate resin; and 10 to 50 wt % of a polyester resin; 1 to 10 parts by weight of a vinyl cyanide compound-aromatic vinyl compound copolymer; and 1 to 10 parts by weight of an inorganic particle; wherein the vinyl cyanide compound in the vinyl cyanide compound-aromatic vinyl compound copolymer is less than or equal to 30 wt %.

The thermoplastic resin may include 60 to 80 wt % of a polycarbonate resin; and 20 to 40 wt % of a polyester resin.

The polyester resin may be a polyethylene terephthalate resin.

The inorganic particle may be talc.

The thermoplastic resin composition may include 1 to 8 parts by weight of the inorganic particle.

The inorganic particle may be talc, a glass particle, mica, graphite, a pearl particle, or a combination thereof.

### Advantageous Effects

One embodiment of the present invention is to provide a thermoplastic resin composition with excellent heat resistance, thermal stability, and dimensional stability while having excellent mechanical properties such as the impact resistance and the like.

### MODE FOR INVENTION

Hereinafter, embodiments of the present invention are described in detail. However, these embodiments are exemplary, and this disclosure is not limited thereto.

As used herein, when specific definition is not otherwise provided, “(meth)acrylate” refers to both “acrylate” and “methacrylate”. In addition, “(meth)acrylic acid alkyl ester” refers to “acrylic acid alkyl ester” and “methacrylic acid alkyl ester”, and “(meth)acrylic acid ester” refers to “acrylic acid ester” and “methacrylic acid ester”.

According to one embodiment of the present invention, provided is a thermoplastic resin composition that includes 100 parts by weight of a thermoplastic resin including 50 to 90 wt % of a polycarbonate resin; and 10 to 50 wt % of a polyester resin; 1 to 10 parts by weight of a vinyl cyanide compound-aromatic vinyl compound copolymer; and 1 to 10 parts by weight of an inorganic particle; wherein an amount of the vinyl cyanide compound in the vinyl cyanide compound-aromatic vinyl compound copolymer is less than or equal to 30 wt %. More specifically, the amount of the vinyl cyanide compound in the vinyl cyanide compound-aromatic vinyl compound copolymer may be 1 to 30 wt % or 1 to 28 wt %.

When the vinyl cyanide compound is less than or equal to about 30 wt % in the vinyl cyanide compound-aromatic vinyl compound copolymer, the phases of polycarbonate resin and polyester resin may be stabilized, and the mechanical characteristics such as Izod impact strength or the like may be uniform and stabilized.

Hereinafter, each component included in the thermoplastic resin composition according to one embodiment of the present invention is specifically explained.

### Polycarbonate Resin

A polycarbonate resin according to one embodiment of the present invention may be prepared by reacting diphenols represented by the following Chemical Formula 1 with a compound selected from phosgene, halogen acid ester, carbonate ester, and a combination thereof.

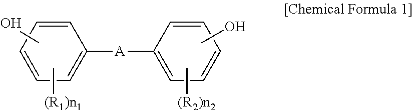

(Wherein the Chemical Formula 1,

A is a linking group selected from a single bond, a substituted or unsubstituted C1 to C30 linear or branched alkylene group, a substituted or unsubstituted C2 to C5 alkenylene group, a substituted or unsubstituted C2 to C5 alkylidene group, a substituted or unsubstituted C1 to C30 linear or branched haloalkylene group, a substituted or unsubstituted C5 to C6 cycloalkylene group, a substituted or unsubstituted C5 to C6 cycloalkenylene group, a substituted or unsubstituted C5 to C10 cycloalkylidene group, a substituted or unsubstituted C6 to C30 arylene group, a substituted or unsubstituted C1 to C20 linear or branched alkoxylene group, a halogen acid ester group, a carbonate ester group, CO, S and SO₂,

each R1 and R2 are independently a substituted or unsubstituted C1 to C30 alkyl group or a substituted or unsubstituted C6 to C30 aryl group,

n1 and n2 are independently integers ranging from 0 to 4, and

the “substituted” refers to one substituted with a substituent selected from a halogen, a C1 to C30 alkyl group, a C1 to C30 haloalkyl group, a C6 to C30 aryl group, a C1 to C20 alkoxy group, and a combination thereof, instead of a hydrogen atom.)

Two or more kinds of the diphenols represented by the Chemical Formula 1 may be combined to constitute a repeating unit of a polycarbonate resin. Specific examples of the diphenols may include hydroquinone, resorcinol, 4,4′-dihydroxydiphenyl, 2,2-bis (4-hydroxyphenyl)propane (referred to be as ‘bisphenol-A’), 2,4-bis (4-hydroxyphenyl)-2-methylbutane, bis (4-hydroxyphenyl)methane, 1,1-bis (4-hydroxyphenyl)cyclohexane, 2,2-bis (3-chloro-4-hydroxyphenyl)propane, 2,2-bis (3,5-dimethyl-4-hydroxyphenyl)propane, 2,2-bis (3,5-dichloro-4-hydroxyphenyl)propane, 2,2-bis (3,5-dibromo-4-hydroxyphenyl)propane, bis (4-hydroxyphenyl)sulfoxide, bis (4-hydroxyphenyl)ketone, bis(4-hydroxyphenyl)ether, and the like. In exemplary embodiments, 2,2-bis (4-hydroxyphenyl)propane, 2,2-bis (3,5-dichloro-4-hydroxyphenyl)propane or 1,1-bis (4-hydroxyphenyl)cyclohexane, for example, 2,2-bis (4-hydroxyphenyl)propane can be used.

The polycarbonate resin may have a weight average molecular weight of 10,000 to 200,000 g/mol, for example 10,000 to 40,000 g/mol. When the weight average molecular weight of the polycarbonate resin is within the range, excellent impact strength may be obtained, and excellent moldability may be obtained due to desirable fluidity. In addition, to improve the fluidity, two or more kinds of polycarbonate resins having different weight average molecular weights may be used.

The polycarbonate resin may be a mixture of copolymers obtained using two or more dipenols that differ from each other. The polycarbonate resin may include a linear polycarbonate resin, a branched polycarbonate resin, a polyestercarbonate copolymer resin, and the like.

The linear polycarbonate resin may include a bisphenol-A-based polycarbonate resin. The branched polycarbonate resin may be produced by reacting a multi-functional aromatic compound such as trimellitic anhydride, trimellitic acid, and the like with diphenols and a carbonate. The multi-functional aromatic compound may be included in an amount of 0.05 to 2 mol % based on the total weight of the branched polycarbonate resin. The polyester carbonate copolymer resin may be produced by reacting difunctional carboxylic acid with diphenols and a carbonate. In this case, diarylcarbonate such as diphenylcarbonate, ethylene carbonate, and the like may be used as the carbonate.

The polycarbonate resin may be included in an amount of 50 to 90 wt %, for example, 60 to 80 wt % based on the total amount of the thermoplastic resin including the polycarbonate resin and the polyester resin. When the polycarbonate resin is included within the range, the heat resistance and impact resistance is excellent, and the improvement of chemical resistance and weather resistance may be expected.

### Polyester Resin

The polyester resin according to one embodiment of the present invention is an aromatic polyester resin and may be used a resin copolymerized by melt polymerizing terephthalic acid or terephthalic acid alkyl ester and a glycol component having 2 to 10 carbon atoms. In this case, the alkyl refers to C1 to C10 alkyl.

The specific examples of the aromatic polyester resin may include a polyethylene terephthalate resin, a polytrimethylene terephthalate resin, a polybutylene terephthalate resin, a polyhexamethylene terephthalate resin, a polycyclohexane dimethylene terephthalate resin, or an amorphous polyester resin modified by partially mixing other monomer with these resins. In exemplary embodiments, the aromatic polyester resin may include a polyethylene terephthalate resin, a polytrimethylene terephthalate resin, a polybutylene terephthalate resin, or an amorphous polyethylene terephthalate resin, for example, a polybutylene terephthalate resin or a polyethylene terephthalate resin.

The polybutylene terephthalate resin is a polymer copolymerized by direct esterifying or ester exchanging a 1,4-butanediol monomer and a terephthalic acid or a dimethyl terephthalate monomer.

In addition, in order to increase the impact strength of polybutylene terephthalate resin, the polybutylene terephthalate resin may be modified by copolymerization with polytetramethylene glycol (PTMG), polyethylene glycol (PEG), polypropylene glycol (PPG), a low molecular weight aliphatic polyester, or an aliphatic polyamide or a modified polybutylene terephthalate resin blended with an impact enhancing component.

The polybutylene terephthalate resin may have an intrinsic viscosity [ᵢ] of about 0.35 to about 1.5 dl/g, for example, about 0.5 to about 1.3 dl/g when measured at 25° C. of o-chloro phenol. When the polybutylene terephthalate resin has the intrinsic viscosity within the range, the mechanical strength and the moldability are enhanced.

The polyethylene terephthalate resin is a linear resin obtained by condensation polymerization of terephthalic acid and ethylene glycol, and includes all of polyethylene terephthalate homopolymer or polyethylene terephthalate copolymer.

In addition, the polyethylene terephthalate copolymer may be an amorphous polyethylene terephthalate copolymer having a copolymer component of 1,4-cyclohexane dimethanol (CHDM), or a copolymer substituting a part of ethylene glycol components with 1,4-cyclohexane dimethanol. In this case, the content of 1,4-cyclohexane dimethanol in the ethylene glycol may range from about 3 to about 48 mol %, for example, from about 5 to about 20 mol %. When the content of 1,4-cyclohexane dimethanol is within the range, the improvement of the surface smoothness and the heat resistance may be expected.

The polyethylene terephthalate resin may have an intrinsic viscosity [η] of about 0.6 to about 1 dl/g, for example, about 0.7 to about 0.9 dl/g. When the polyethylene terephthalate resin has the intrinsic viscosity within the range, the mechanical strength and the moldability can be enhanced.

The polyester resin may be included in about 10 to about 50 wt %, for example, about 20 to about 40 wt % based on the total amount of thermoplastic resin including the polycarbonate resin and the polyester resin. When the polyester resin is included within the range, the heat resistance and the impact resistance are enhanced, and the improvement of chemical resistance and weather resistance may be expected.

### Vinyl Cyanide Compound-Aromatic Vinyl Compound Copolymer

The vinyl cyanide compound-aromatic vinyl compound copolymer resin according to one embodiment of the present invention may be used for enhancing the compatibility of the polycarbonate resin and the polyester resin, thereby the increasing a size of polyester resin domain can be suppressed during the cooling step in the injection process, and the post deformation due to the slow crystallization of polyester resin can be suppressed. Wherein the “domain” means a discontinuous phase and is a term comparative to ‘matrix’ which is a continuous phase.

The vinyl cyanide compound-aromatic vinyl compound copolymer includes a vinyl cyanide compound in less than or equal to 30 wt %, for example, 1 to 30 wt %, 1 to 28 wt %, 1 to 26 wt % in the copolymer. When the vinyl cyanide compound is included greater than 30 wt %, the phase of polycarbonate resin may be broadly distributed to deteriorate the impact resistance.

The vinyl cyanide compound-aromatic vinyl compound copolymer may have a weight average molecular weight of about 40,000 to about 500,000 g/mol.

As the vinyl cyanide compound, acrylonitrile, methacrylonitrile, or a mixture thereof may be used.

The aromatic vinyl compound may be styrene, α-methyl styrene, halogen or alkyl substituted styrene, or a mixture thereof.

The vinyl cyanide compound-aromatic vinyl compound copolymer may be prepared according to the emulsion polymerization, the suspension polymerization, the solution polymerization, the bulk polymerization or the like.

The vinyl cyanide compound-aromatic vinyl compound copolymer may be included in 1 to 10 parts by weight, for example, 2 to 8 parts by weight based on 100 parts by weight of thermoplastic resin including the polycarbonate resin and the polyester resin. When the vinyl cyanide compound-aromatic vinyl compound copolymer is included within the range, the compatibility of the polycarbonate resin with the polyester resin is improved, and also the impact resistance, the mechanical strength, and the heat resistance are improved. Inorganic particle

The thermoplastic resin composition may further include an inorganic particle.

The inorganic particle may be another kind of sparkling particle having a smooth plane which can reflect light.

The inorganic particle may include talc, a glass particle, mica, graphite, a pearl particle, or a combination thereof, for example, a glass particle may be used.

The glass particle has a sheet-shaped structure, thus it is different from the glass fiber mainly having a cylinder shape. The glass particle may have a cross-sectional surface of circular, oval, amorphous and the like.

The inorganic particle may have an average particle diameter of 10 to 200 μm and a thickness of 0.5 to 10 μm, and the cross-sectional area may range from 80 to 32,000 μm². When the inorganic particle has the average particle diameter, the thickness, and the cross-sectional area within the ranges, the molded article may be provided with rarely generating the flow mark and the weld line.

The inorganic particle may be included in 1 to 10 parts by weight, for example, 1 to 8 parts by weight based on 100 parts by weight of the thermoplastic resin. If satisfying the range, it is desirable for providing a molded article with the excellent impact strength and with rarely generating the flow mark and the weld line.

### Other Additive

The thermoplastic resin composition may further include additives such as an antibacterial agent, a heat stabilizer, an antioxidant, a release agent, a light stabilizer, a surfactant, a coupling agent, a plasticizer, an admixture, a colorant, a stabilizer, a lubricant, an anti-static agent, a coloring aid, a flame-proofing agent, a weather-resistance agent, an ultraviolet (UV) absorber, an ultraviolet (UV) blocking agent, a nucleating agent, an adhesion aid, an adhesive or a a combination thereof.

The antioxidant may include phenol, phosphite, thioether, or amine-type antioxidant, and the release agent may include fluorine-included polymer, silicone oil, montanic acid ester wax, or polyethylene wax. In addition, as the weather-resistance agent, benzophenone-type benzotriazole-type or phenyltriazine-type may be used; as the colorant, dye or pigment may be used; and as the ultraviolet (UV) blocking agent, titanium dioxide (TiO₂) or carbon black may be used. In addition, as the nucleating agent, talc or clay may be used.

The additives may be appropriately included within the range as long as not suppressing the properties of the thermoplastic resin composition. In exemplary embodiments, the additives may be included in less than or equal to about 40 parts by weight, for example, about 0.1 to about 30 parts by weight based on 100 parts by weight of the thermoplastic resin.

The thermoplastic resin composition may be prepared according to the known method for preparing a resin composition. For example, the composition components according to one embodiment and other additives may be simultaneously mixed and then melt-extruded in an extruder to provide a pellet.

According to another embodiment, the thermoplastic resin composition is molded to provide a molded article. In other words, a molded article may be manufactured using the thermoplastic resin composition according to various processes, such as injection molding, blow molding, extrusion, compression molding, and the like. Particularly, it may be usefully applied to a molded article, particularly, a plastic exterior product such as electric-electronic parts, vehicle parts, and the like.

Hereinafter, preferable examples of the present invention are described. These examples, however, are not in any sense to be interpreted as limiting the scope of the invention.

### EXAMPLES

Thermoplastic resin compositions are prepared according to the following Table 1.

TABLE 1

| | | | | | Comparative | | | |
|---|---|---|---|---|---|---|---|---|
| | | Examples | | | Examples | | | |
| | | 1 | 2 | 3 | 1 | 2 | 3 | 4 |
| (A) Polycarbonate (wt %) | | 67 | 64 | 73 | 65 | 60 | 68 | 63 |
| (B) Polyethylene terephthalate (wt %) | | 33 | 36 | 27 | 35 | 40 | 34 | 37 |
| (C) Vinyl cyanide compound- | (C-1) | | | | 5 | | | |
| aromatic vinyl compound copolymer | (C-2) | 5 | 4 | 4 | | | 3 | 5 |
| (parts by weight) | | | | | | | | |

| | | | | | | |
|---|---|---|---|---|---|---|
| (D) inorganic particle (parts by weight) | 5 | 6 | 4 | 6 | 6 | 12 |

The description for each component used in Table 1 is as follows:
(A) Polycarbonate resin
SC-1080 product having a weight average molecular weight of 28,000 g/mol, manufactured by Cheil Industries Inc., is used.
(B) Polyethylene terephthalate resin
SKYPET 1100 product having an intrinsic viscosity [η] of 0.77 dl/g, manufactured by SK Chemical, is used.
(C) Vinyl cyanide compound-aromatic vinyl compound copolymer
(C-1) vinyl cyanide having a weight average molecular weight of about 120,000 g/mol and including 60 wt % of styrene and 40 wt % of acrylonitrile is used.
(C-2) vinyl cyanide compound-aromatic vinyl compound copolymer having a weight average molecular weight of about 120,000 g/mol and including 76 wt % of styrene and 24 wt % of acrylonitrile is used.
(D) Inorganic particle
As the talc, UPN HS-T 0.5 manufactured by Hayashi Kasei is used.

### Examples 1 to 3 and Comparative Examples 1 to 4

Using the composition components, the thermoplastic resin compositions according to Examples 1 to 3 and Comparative Examples 1 to 4 are prepared according to the composition shown in Table 1, and then extruded by the commonly used twin-screw extruder in the temperature range of 240 to 270° C. to provide pellets. In Table 1, by setting the contents of (A) and (B) as (A)+(B)=100 wt %, the content of each (A) and (B) was defined in a unit of wt %, and (C) and (D) are shown in the relative content (parts by weight) based on the (A)+(B)=100 parts by weight.

Each pellets obtained from Examples 1 to 3 and Comparative Examples 1 to 4 are dried at 110° C. for 4 hours, and then ASTM specimens are injection molded using an injection molding machine having an injection capacity of 6 oz and set with a cylinder temperature of 240 to 270° C., a mold temperature of 80° C., and a molding cycle time of 30 seconds to provide specimens.

The property measuring results of obtained specimens are shown in the following Table 2.

TABLE 2

| | | Examples | | | Comparative Examples | | | |
|---|---|---|---|---|---|---|---|---|
| | | 1 | 2 | 3 | 1 | 2 | 3 | 4 |
| IZOD (avg.) | 1/8″ | 47 | 45 | 50 | 43 | 47 | 79 | 12 |
| IZOD (stdev.) | 1/8″ | 2.1 | 1.7 | 2.0 | 10 | 11 | 2.7 | 2.5 |
| CTE | Flow direction | 73.29 | 72.59 | 74.22 | 72.85 | 71.70 | 85.63 | 63.26 |
| (−25-50° C.) | Cross-flow direction | 75.58 | 74.47 | 76.07 | 77.47 | 76.45 | 92.87 | 65.59 |

The IZOD impact strength is measured according to the ASTM D256 method, and the CTE (coefficient of thermal expansion) is measured according to the ASTM E381 method.

In Table 2, the IZOD (avg.) means an averaged value, and the IZOD (stdev.) means a standard deviation.

As shown in Table 2, it is understood that the thermoplastic resin compositions according to Examples 1 to 3 have excellent impact strength and simultaneously ensured the dimensional stability. In addition, comparing Example 2 with Comparative Example 2, the IZOD averaged values are insignificantly different, but the standard deviation of IZOD is significantly less in the case that the vinyl cyanide compound-aromatic vinyl compound copolymer has an acrylonitrile content of 24 wt % (Example 2) than the case of 40 wt % (Comparative Example 2), so as to accomplish the uniform and stable properties.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A thermoplastic resin composition, comprising
100 parts by weight of a thermoplastic resin including 50 to 90 wt % of a polycarbonate resin; and 10 to 50 wt % of a polyester resin;
1 to 10 parts by weight of a vinyl cyanide compound-aromatic vinyl compound copolymer; and
1 to 10 parts by weight of an inorganic particle;
wherein the vinyl cyanide compound in the vinyl cyanide compound-aromatic vinyl compound copolymer is less than or equal to 30 wt %.

2. The thermoplastic resin composition of claim 1, wherein the thermoplastic resin comprises 60 to 80 wt % of a polycarbonate resin; and 20 to 40 wt % of a polyester resin.

3. The thermoplastic resin composition of claim 1, wherein the polyester resin is a polyethylene terephthalate resin.

4. The thermoplastic resin composition of claim 1, wherein the inorganic particle is talc.

5. The thermoplastic resin composition of claim 1, wherein the thermoplastic resin composition comprises 1 to 8 parts by weight of the inorganic particle.

6. The thermoplastic resin composition of claim 1, wherein the inorganic particle is talc, a glass particle, mica, graphite, a pearl particle, or a combination thereof.
